(19) United States
(12) Patent Application Publication
(10) Pub. No.: US 2008/0189029 A1
(43) Pub. Date: Aug. 7, 2008

(54) Route Calculation Method and Device with Progressive Elimination of Data Corresponding to the Road Network

(76) Inventors: Pierre Hayot, Clamart (FR); Christophe Legrand, Fontenay-Le Fleury (FR)

Correspondence Address: BUCHANAN, INGERSOLL & ROONEY PC, POST OFFICE BOX 1404, ALEXANDRIA, VA, 22313-1404, US

(21) Appl. No.: 11/665,653

(22) PCT Filed: Oct. 13, 2005
(86) PCT No.: PCT/EP2005/011005

§ 371 Date: Mar. 12, 2008

(30) Foreign Application Priority Data
Oct. 18, 2004 (FR) 0411029

(51) Int. Cl. G01C 21/34

(52) U.S. Cl. 701/201

(57) ABSTRACT

A method of determining routes between a point of departure(a) and a point of arrival (β) comprising the following steps:

a) the nodes surrounding a departure node are scanned so as to determine the cost of each of these nodes;

b) said scanning is continued until the point of arrival of the route is reached;

c) during said scanning, the nodes are scanned so as to identify the nodes that can be used to form a mesh with a given starting index Id;

d) when a mesh with an index Id is identified, the nodes and segments whose index is less than this index Id are eliminated;

e) scanning the nodes continues so as to identify the nodes that can be used to form a new mesh, whose index Is is greater than that of the preceding mesh;

f) nodes and segments whose index is less than this new index Is are eliminated;

g) steps e and f are repeated until the desired elimination level is reached.

The present invention relates to a method and a device for establishing routes in a fast, accurate and efficient way, using a different number of basic data according to the different steps in calculation. Thus, as the calculation progresses, a data hierarchy is created, in such a way that certain data are no longer considered for subsequent calculations. The routes established can be used for putting together route sheets (list of instructions for traveling from one point to another) and/or for producing map illustrations of the calculated journey.

For some years now, suppliers of digital data representing road networks (or other transport networks such as rail or sea) have been confronted with a marked increase in the amount of data. This growth stems from several sources. Road networks are becoming denser, expanding, etc. The data relating to networks are increasingly numerous, since it is increasingly useful and relevant to consider parameters other than just nodes, segments and their spatial coordinates. For example, additional indications such as speed limits, direction and location indications, tourist information, etc., are more and more appreciated by users. Furthermore, all these data are increasingly subject to frequent or temporary changes. The databases are therefore increasingly bloated, which has a negative impact on access and calculation times. Moreover, database updates are becoming increasingly tedious.

Data users, e.g. for producing routes, whether for themselves or for others, are increasingly confronted with difficulties associated with the growth in the amount of data, and with the negative impact that this represents on the time needed to generate a route, following a request from a user. This aspect is especially critical for remote route providers, who are having to cope with a major increase in both the number of users and the number of requests per user. It is therefore increasingly difficult to maintain the times and load levels of the tools at acceptable levels.

To remedy these different drawbacks, the invention provides a method of determining routes between a point of departure (a) and a point of arrival (β) for a digital road mapping system consisting of a set of segments and nodes each having their importance index, said nodes and segments being put together so as to represent a road network formed of a plurality of meshes of different importance indices, each of the meshes being defined by a set of nodes of identical or greater value than a given value, defining an area, said method comprising the following steps:

a) via the segments, the nodes surrounding a departure node are scanned so as to determine the cost of each of these nodes;

b) said scanning is continued until the point of arrival of the route is reached;

c) during said scanning, the nodes are scanned so as to identify the nodes that can be used to form a mesh with a given starting index Id;

d) when a mesh with an index Id is identified, the segments (and therefore implicitly the nodes) whose index is less than this index Id are eliminated;

e) scanning the nodes continues so as to identify the nodes that can be used to form a new mesh, whose index

Is is greater than that of the preceding mesh;

f) segments whose index is less than this new index Is are eliminated;

g) steps e and f are repeated until:

either the scanning enables the point of arrival of the route to be reached;

or a maximum index Im of elimination is reached.

For forming a mesh, nodes of importance Is or over are counted, which means that a mesh is not necessarily homogeneous in terms of importance value.

A mesh is regarded as closed when all the nodes belonging to the scanning boundary are of equal or greater importance than the level of importance that it is desired to eliminate. In the case of “cul de sac” type segments, very often their end nodes do not allow a mesh to be closed, however, at a given moment these will naturally drop out of the scanning tree.

This method provides a sensible way to control the amount of data to be processed, while finding a balance between the necessary time and calculation capabilities, and the quality of the routes produced, for which the demands are increasingly greater. This type of elimination further reflects a logic that well suits route users since it enables them to take networks of lesser importance on departure and arrival, and the more important networks between these two portions, when the length of the journey allows this. This results in a structural simplification of the routes proposed. Moreover, since there is a direct relationship (y=f(x)) between the number of segments scanned during the course of the graph and the time needed for the complete calculation, the reduction in the number of segments to be scanned on a portion of the journey can offer considerable gains in time and in level of strain on resources, e.g. occupation of memory space.

According to the embodiments, the starting importance index can be preset, or set at the lowest possible value as a function of the indices corresponding to the nodes present in the departure point area, e.g. with a value corresponding to the index of the mesh with the lowest identifiable index around the point of departure. According to an advantageous embodiment, a maximum index Im is either preset, or supplied by the user. This index can be used to limit the elimination process to a given stage. For example, according to an advantageous embodiment, for an index scale from 1 to 20, Id is equal to 8 and Imax is equal to 13. This example provides a very advantageous elimination, while sufficiently preserving elements to achieve an excellent level of quality.

According to the envisaged embodiment, the phases of elimination can be implemented either by step, for example after each transition to a higher mesh level, or after several level changes, in grouped fashion.

It is considered that when on the graph on which the desired elimination is performed, termed a flight graph, the secondary network is effectively useless up to the outskirts of the arrival point. In cases where the user wishes to obtain the shortest route between two points, the present invention means that a calculated route is not necessarily the shortest. It is rather a compromise corresponding to the shortest route following the main roads, or favoring the network with a higher index.

For retaining logical routes, it is preferable that the road graph used during the calculation meets relationship constraints by level of importance and especially for the flight graph.

The method according to the invention, consisting in ignoring a part of the road network enables the number of segments to be analyzed to be considerably reduced (e.g. up to nearly ten times less according to an envisaged embodiment) whilst achieving a result comparable to a calculation performed without elimination.

It is clear, with this principle, that the result of this method is to produce an adaptation dependent on the area, i.e. rapid elimination in dense zones (towns) and slower elimination in parts of lower density.

Advantageously, the nodes are scanned so as to progressively form meshes whose index increases regularly.

Advantageously, the index of a subsequent mesh corresponds to the index following that of the immediately preceding mesh. It may or may not be a regular increment. For example, an increment of 1 (or another value) between values from 1 to 20. The increment value may also be any function.

Advantageously, the importance index of a node corresponds to the highest index of the incident segments.

According to an advantageous embodiment, in order to determine the route, a plurality of potential routes is identified from which one route is selected according to given criteria.

The preferred route is preferably that for which the total cost between the point of departure and the point of arrival is optimal. Obviously establishing this cost can be done taking into account a number of more or less important parameters, according to circumstances. For example, parameters such as the distance traveled, tolls, journey time, saving in gas, etc. can be considered. Each of these different parameters may take on a more or less decisive importance, by associating more or less important weightings with each one, according to circumstances, e.g. as a function of one or more of the user's wishes.

According to an advantageous embodiment, the plurality of routes is identified by selecting a first modeling element of the road network, preferably a node, close to the point of departure (a), and a second modeling element of the road network, preferably a node, close to the point of arrival (β), identifying a plurality of routes, each consisting of a plurality of route elements connected from the first element to the second element, and searching for at least one intermediate element for each of said routes in said set of road network modeling elements.

Advantageously, scanning the nodes is carried out using Dijkstra's algorithm. According to another advantageous embodiment, scanning the nodes is carried out using FORD's algorithm.

The invention also provides software comprising code elements programmed for implementing the previously disclosed method, when said software is loaded into a computer system and executed by said computer system.

This software may be in the form of a product recorded onto a machine-readable medium, comprising programmed code elements as disclosed above.

The invention further provides a route calculation device, comprising:

a data input unit, for receiving the data associated with a point of departure a and those associated with a point of arrival β;

access to a storage unit comprising a set of road network modeling elements;

a calculation unit designed for identifying a plurality of routes enabling each to connect the points of departure and arrival;

means of elimination, first for identifying at least one elimination level or threshold and secondly for eliminating at least one portion of the basic set of data whose index is below said elimination level or threshold.

According to an advantageous embodiment, the device includes a guidance unit, designed to generate guidance information as a function of the mapping elements of the selected route.

Finally, the invention provides a computer system comprising a device as previously disclosed.

All the details of embodiment are given in the description that follows, completed by FIGS. 1 to 15 in which:

FIGS. 1 to 6 illustrate the principle known in itself of Dijkstra's algorithm;

FIG. 7 illustrates an example of a mesh;

FIG. 8 illustrates the principle of inheritance;

FIGS. 9 and 10 show an example of formation of a mesh of a certain level, in order to be able to eliminate the lower level data;

FIG. 11 illustrates another example of a mesh;

FIGS. 12 and 13 illustrate an example of propagation, with and without elimination respectively;

FIGS. 14 and 15 illustrate an example of propagation in a departure area, with and without elimination respectively.

In the present description, the following terms are used in particular with the following meanings:

“Node” refers to a point of intersection between a first mapping or road network (or other network) element and a second element of such a network, in particular the intersection between a plurality of roadways. A node also refers to a point of physical or qualitative change in a segment, as for example passing from two to three lanes, a change in speed limit, an area of (even temporary) road works, a break point such as a border, etc.

“Segment” refers to a portion of road between two nodes.

“Route” refers to a subset of points stemming from the modeling elements of a road network, creating a link between the data enabling them to model or represent a journey or path on said road network used to connect a point of departure and a point of arrival. This subset is composed of data relating to the segments used to connect the departure and arrival. Data relating to the segments is understood to mean the identifications, lengths and spatial coordinates of the segments.

This subset can be used to represent said route in different forms, e.g. by means of a graphical representation, preferably in the form of a map including the point of departure, the point of arrival and the segments forming said route, or in the form of a “route sheet” or list of instructions, comprising a listing or series of instructions either written or represented by pictograms, explaining to a possible driver of a vehicle, the different steps to follow for taking said route.

Today, different approaches and different algorithms can be used to calculate routes. The present invention is capable of being used with a large number of them. For example, the method according to the invention is especially suited to Dijkstra's algorithm, which is widely used in the field of route calculations.

FIGS. 1 to 6 illustrate the principle of Dijkstra's algorithm. Given a graph, such as that in FIG. 1, representing the road network, comprising nodes interconnected by evaluated segments (distance between nodes):

A point of departure is chosen (e.g. H); Dijkstra's algorithm can be used to find, for each node, the shortest distance between this node and H. FIGS. 1 to 6 illustrate the operation of the algorithm.

First step (FIG. 2): the departure node is evaluated at 0.

Second step (FIG. 3): each segment from the departure is followed and the nodes encountered are evaluated.

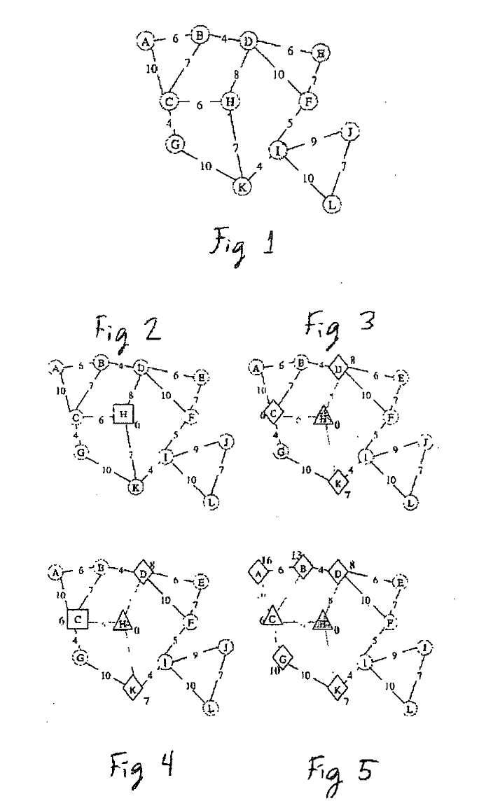

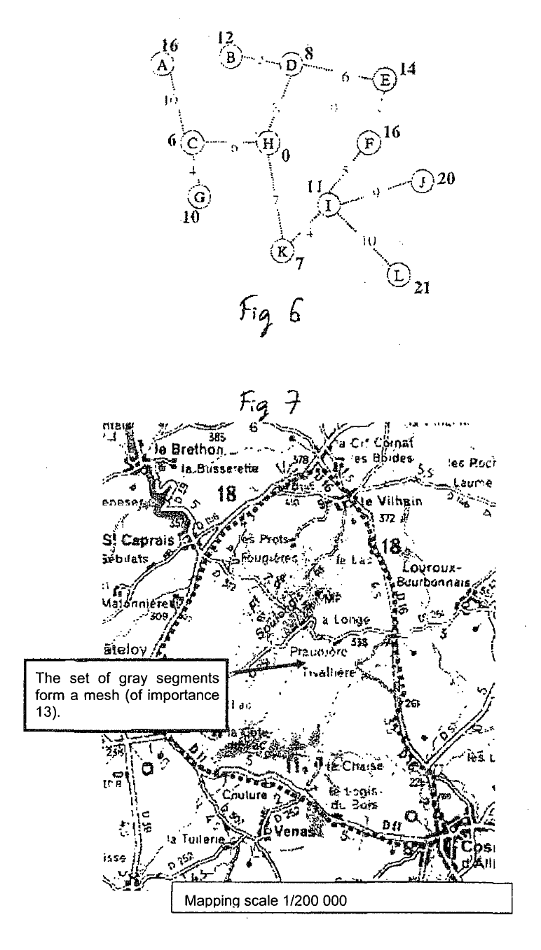

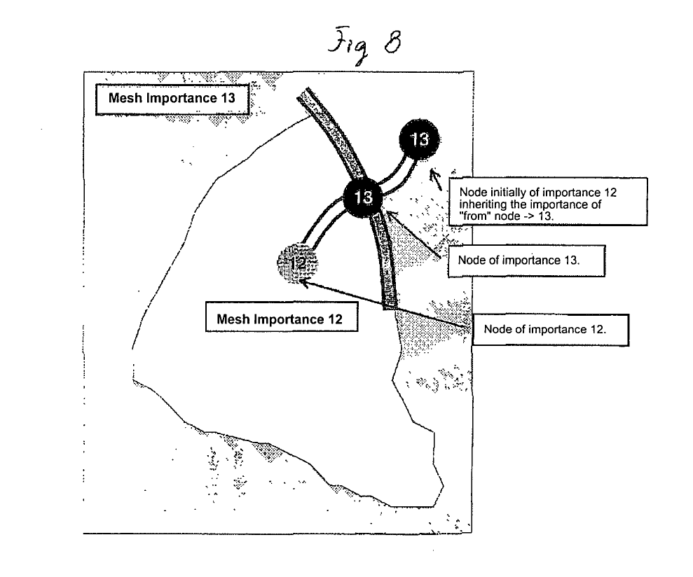

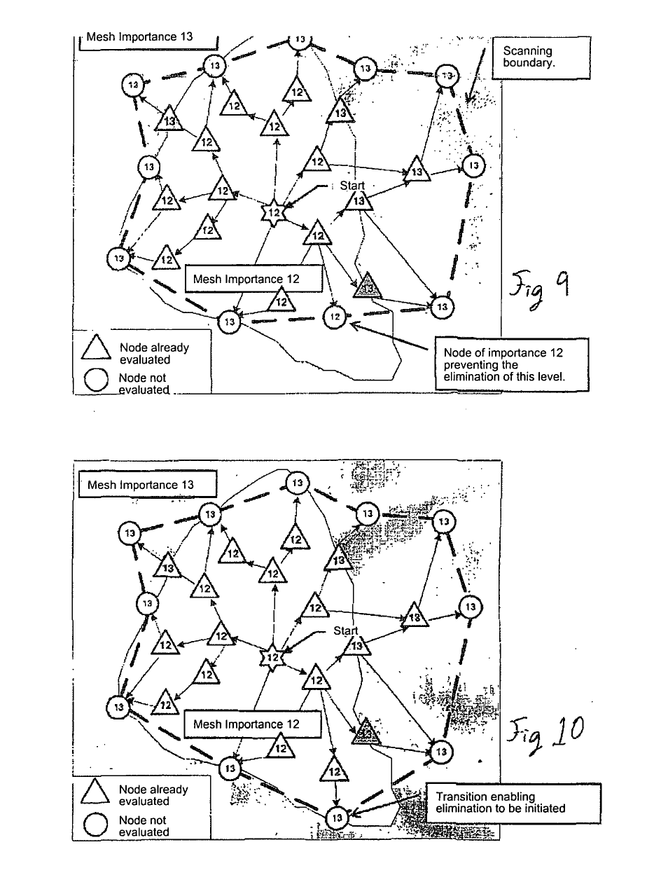

Third step (FIG. 4): from the evaluated nodes that of least cost (C) is selected.

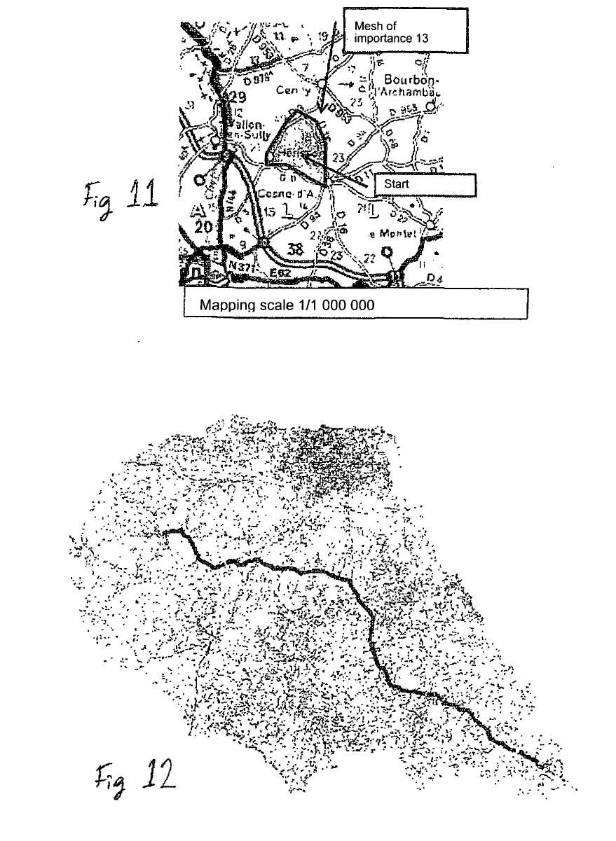

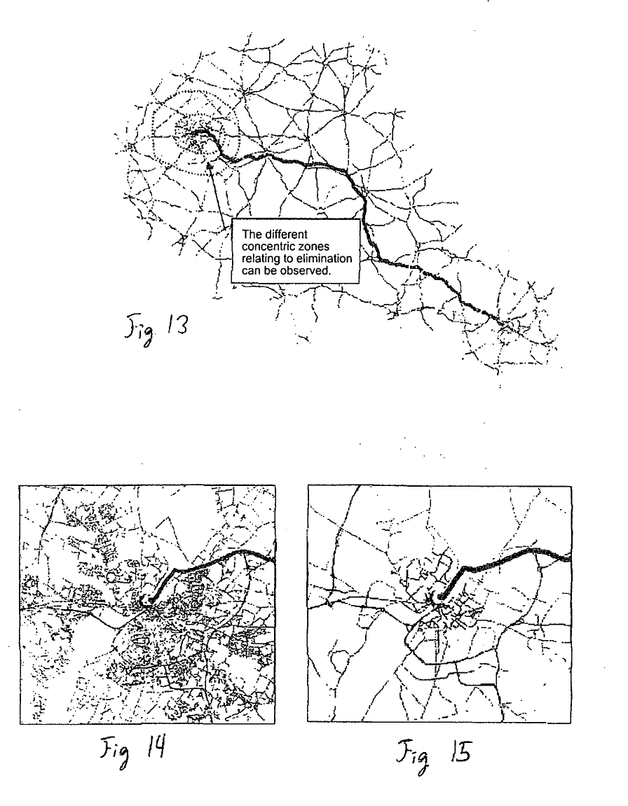

Fourth step (FIG. 5): all the segments leaving from the selected point are followed, and the nodes encountered are evaluated (first evaluation or updating).

Subsequently, K will be selected next, then all the nodes progressively. Until a node is definitively evaluated, its valuation may change. For example, B will be evaluated as 12 via D. In the end, the result shown in FIG. 6 is obtained.

Route calculation is begun from the point of departure a and ends as soon as the arrival node is definitively evaluated. The best route is thus obtained. In order to calculate different types of possible routes, the cost associated with the segment may be associated with different parameters such as for example:

the journey time (the fastest route);

the length (the shortest route);

or a combination of the two.

To preserve an acceptable level of performance, the solution of the invention consists in ignoring a part of the graph during the calculation, while continuing to serve all the points of the road network (towns, addresses, POI, etc.) consistently.

Overall, the concept of the invention is based on the existence of a main graph, termed a “flight graph”, representative of the major roads and very limited in number of objects, which are joined from the points of departure and arrival by following a “secondary” graph containing all the minor roads. Once the flight graph is achieved, the secondary graph is ignored until the outskirts of the arrival point. These different levels are based on the importance of the road network. In the data commonly used by the applicant this takes the form of a range of theoretical values from 1 to 20. In actual fact, only the values from 8 to 20 are significant. The following table shows this example of the distribution of importance indices with respect to the road network typology:

| Importance | Road type | 15 |
|---|---|---|
| 20 | | |
| 19 | Very large network: Freeway type | |
| 18 | | |
| 17 | | 20 |
| 16 | Large network: Routes Nationales [main highways] | |
| 15 | | |
| 14 | Regional network: secondary roads | |
| 13 | | 25 |
| 12 | Local network | |
| 11 | | |
| 10 | | |
| 9 | Urban network | |
| 8 | | 30 |

The remaining problem consists in defining the method for identifying the threshold from which to choose to remain on the flight graph taking into account the fact that the density of the road network is not homogeneous. The choice of the mode of elimination is focused on a method that is “adaptive” for taking into account the density of the road network and “progressive” for eliminating the networks by successive levels (according to the importance level: from 1 to 20).

From a principle standpoint, it is considered that the road network is a set of meshes of differing importance and that all the segments forming a mesh are of the same importance, as shown in the example of FIG. 7.

Preferably, it is considered that the importance of an intersection is at least equivalent to that of the “from” node, if not it is raised (inheritance). FIG. 8 displays this inheritance mechanism.

The choice of eliminating a network level is made as soon as all the nodes forming the network scanning boundary are of a higher importance. The charts in FIGS. 9 and 10 display the propagation of the calculation and the scanning boundary.

The nodes represented by circles in FIGS. 9 and 10, forming the scanning boundary, are not all of the importance level required for eliminating level 12. Therefore analysis of the segments of this importance is continued.

In FIG. 10, the last node preventing elimination has been evaluated and has enabled a new intersection of sufficient importance level to be reached. From this moment, the segments of an importance less than 13 will no longer be examined.

This principle of elimination can certainly be compared to a kind of change of scale during calculation, as illustrated by the map insert in FIG. 11, which brings out the geographical area of the start of the route and the mesh that has been used for the elimination of the graph.

FIG. 12 shows the propagation of a route calculation without elimination on a journey Angers/Lyons. The whole network is scanned. The thick line indicates the path accepted by the computer.

By implementing the progressive elimination mechanism, the result shown in FIG. 13 is obtained.

In creating a route between areas of high density, it is seen that the network of low importance is very quickly eliminated. By zooming onto the point of departure areas relative to elimination levels can be observed more clearly, as shown in FIGS. 14 and 15.

It is important to note that this principle of selecting a main network is quite consistent with the natural behavior of a driver seeking to avoid roads of too small importance when traveling, while nevertheless forced to follow them at the start and/or on arrival.

1. A method of determining routes between a point of departure (a) and a point of arrival (β) for a digital road mapping system consisting of a set of segments and nodes each having their importance index, said nodes and segments being put together so as to represent a road network formed of a plurality of meshes of different importance indices, each of the meshes being defined by a set of nodes of identical or greater value than a given value, defining an area, said method comprising the following steps:
a) via the segments, the nodes surrounding a departure node are scanned so as to determine the cost of each of these nodes;
b) said scanning is continued until the point of arrival of the route is reached;
c) during said scanning, the nodes are scanned so as to identify the nodes that can be used to form a mesh with a given starting index Id;
d) when a mesh with an index Id is identified, the segments whose index is less than this index Id are eliminated;
e) scanning the nodes continues so as to identify the nodes that can be used to form a new mesh, whose index Is is greater than that of the preceding mesh;
f) segments whose index is less than this new index Is are eliminated;
g) steps e and f are repeated until:
either the scanning enables the point of arrival of the route to be reached;
or a maximum index Im of elimination is reached.

2. The method of determining routes as claimed in claim 1, characterized in that the nodes are scanned so as to progressively form meshes whose index increases regularly.

3. The method of determining routes as claimed in claim 1, characterized in that the index of a subsequent mesh corresponds to the index following that of the immediately preceding mesh.

4. The method of determining routes as claimed in claim 1, characterized in that the importance index of a node corresponds to the highest index of the incident segments.

5. The method of determining routes as claimed in claim 1, characterized in that in order to determine the route, a plurality of potential routes is identified from which one route is selected according to given criteria.

6. The method of determining routes as claimed in claim 1, characterized in that the plurality of routes is identified by selecting a first modeling element of the road network, preferably a node, close to the point of departure, and a second modeling element of the road network, preferably a node, close to the point of arrival, identifying a plurality of routes, each consisting of a plurality of route elements connected from the first element to the second element, and searching for at least one intermediate element for each of said routes in said set of road network modeling elements.

7. The method of determining routes as claimed in claim 1 in which scanning the nodes is carried out using Dijkstra's algorithm.

8. The method of determining routes as claimed in claim 1, in which scanning the nodes is carried out using FORD's algorithm.

9. Software comprising code elements programmed for implementing the method as claimed in claim 1, when said software is loaded into a computer system and executed by said computer system.

10. The software as claimed in claim 9, in the form of a product recorded onto a machine-readable medium, comprising programmed code elements.

11. A route calculation device, comprising:
a data input unit, for receiving the data associated with a point of departure and those associated with a point of arrival;
access to a storage unit comprising a set of road network modeling elements;
a calculation unit designed for identifying a plurality of routes enabling each to connect the points of departure and arrival;
means of elimination, first for identifying at least one elimination level or threshold and secondly for eliminating at least one portion of the basic set of data whose index is below said elimination level or threshold.

12. The device as claimed in claim 11, including a guidance unit, designed to generate guidance information as a function of the mapping elements of the selected route.

13. A computer system including a device as claimed in claim 11.
